(19) United States
(12) Patent Application Publication
(10) Pub. No.: US 2015/0088572 A1
(43) Pub. Date: Mar. 26, 2015

(54) SYSTEM AND METHOD FOR MANAGING A MEETING SESSION IN A NETWORK ENVIRONMENT

(71) Applicant: CISCO TECHNOLOGY, INC., SAN JOSE, CA (US)

(72) Inventors: Lan Betty Ngoc Mai, Seattle, WA (US); Joshua Pacheco Rose, Seattle, WA (US); Alan Darryl Gatzke, Bainbridge Island, WA (US)

(73) Assignee: CISCO TECHNOLOGY, INC., SAN JOSE, CA (US)

(21) Appl. No.: 14/038,498

(22) Filed: Sep. 26, 2013

(51) Int. Cl. G06Q 10/10

(52) U.S. Cl. CPC G06Q 10/1093
USPC 705/7.18

(57) ABSTRACT

An example method is provided and includes receiving status information from a number of endpoints associated with a meeting session in a network environment, where the status information includes, at least, information indicative of whether any of the number of endpoints have virtually checked into the meeting session. The method can also include receiving anticipated arrival information from a checked in endpoint; and generating a representation of the anticipated arrival information to be viewed during the meeting session.

### TECHNICAL FIELD

This disclosure relates in general to the field of communications and, more particularly, to managing a meeting session in a network environment.

### BACKGROUND

In certain architectures, service providers and/or enterprises may seek to offer sophisticated online conferencing services for their end users. The conferencing architecture may offer an “in-person” meeting experience over a network. Conferencing architectures may also deliver real-time interactions between people using advanced visual, audio, and multimedia technologies. Virtual meetings and conferences have an appeal because they may be held without the associated travel inconveniences and costs. In addition, virtual meetings may provide a sense of community to participants who are dispersed geographically. There are new interactive paradigms that have emerged that differ from face-to-face interactions.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram of a communication system for managing a meeting session in accordance with at least one example embodiment;

FIG. 2 is an illustration showing example user interface representations associated with a meeting client program according to at least one example embodiment;

FIG. 3 is an illustration showing example user interface representations associated with a meeting client program according to at least one example embodiment;

FIG. 4 is a flow diagram illustrating activities associated with managing anticipated arrival information according to at least one example embodiment;

FIG. 5 is a flow diagram illustrating activities associated with managing status and anticipated arrival information according to at least one example embodiment; and

FIG. 6 is a simplified schematic diagram illustrating possible details related to an example infrastructure of a communication system in accordance with at least one example embodiment.

### DETAILED DESCRIPTION OF EXAMPLE EMBODIMENTS

### Overview

An example method is provided and includes receiving status information from a number of endpoints associated with a meeting session in a network environment, where the status information includes, at least, information indicative of whether any of the number of endpoints has virtually checked into the meeting session. The method can also include receiving anticipated arrival information from a checked in endpoint; and generating a representation of the anticipated arrival information to be viewed during the meeting session.

In more particular embodiments, the anticipated arrival information is provided by a message from the checked in endpoint. In addition, the anticipated arrival information can include an estimated time of arrival of the checked in endpoint based, at least in part, on global positioning system (GPS) technology. Additionally, the method can potentially include calculating an estimated time of arrival of the checked in endpoint using location information; and updating the anticipated arrival information with the estimated time of arrival.

### EXAMPLE EMBODIMENTS

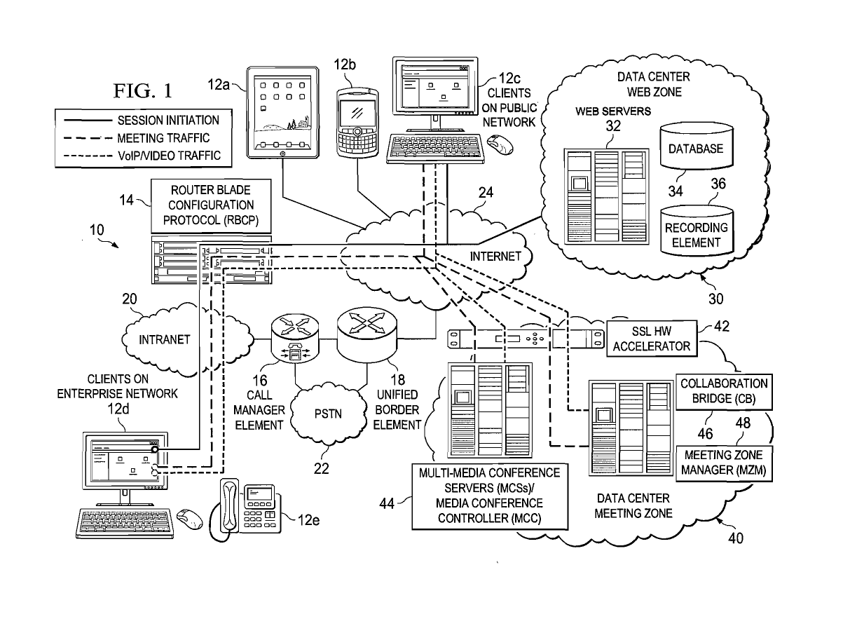

FIG. 1 is a simplified schematic diagram of a communication system 10 for managing a meeting session in accordance with at least one example embodiment. Communication system 10 may include a number of endpoints 12a-e that may achieve suitable network connectivity via various points of attachment. In the example of FIG. 1, communication system 10 includes an Intranet 20, a public switched telephone network (PSTN) 22, and an Internet 24, which (in this particular example) offers a pathway to a data center web zone 30 and a data center meeting zone 40.

Data center web zone 30 includes a plurality of web servers 32, a database 34, and a recording element 36. Data center meeting zone 40 includes a secure sockets layer hardware (SSL HW) accelerator 42, a plurality of multimedia conference servers (MCSs)/media conference controller (MCC) 44, a collaboration bridge 46, and a meeting zone manager 48. In at least one example embodiment, each MCS may be configured to coordinate video and voice traffic for a given online meeting. Additionally, each MCC may be configured to manage the MCS from data center meeting zone 40.

Various types of routers and switches may be used to facilitate communications amongst any of the elements of FIG. 1. For example, a call manager element 16 and a unified border element 18 may be provisioned between PSTN 22 and Intranet 20. Also depicted in FIG. 1 are a number of pathways (e.g., shown as solid or broken lines) between the elements for propagating meeting traffic, session initiation, and voice over Internet protocol (VoIP)/video traffic.

Note that, as a general proposition, in virtual meeting environments, an invitee may be late for a meeting for which they intend to attend. Currently, no mechanism exists that makes it easy or practical for the invitee to inform others in the meeting that an individual is running late, or to inform others of an estimated time of arrival for the late attendee. Further, few mobile applications track location (e.g., via a mobile endpoint) and have accompanying intelligence to update friends/contacts on a current location and/or estimated time of arrival for upcoming events. Even if such a mobile solution existed, all participants in a meeting would have to run the same mobile application in order to retrieve the location updates and estimated time of arrival (ETA). The various embodiments in this disclosure provide location and ETA functionality within a virtual conferencing environment to address and/or resolve these aforementioned issues.

One or more embodiments provide a mobile client application that allows an invitee to check into a meeting to which they have been invited. The invitee can check into a meeting prior to the start of the meeting (i.e., any number of minutes prior). Once the invitee has checked into the meeting, the invitee can then be displayed in the meeting's participant list with an indicator (icon, graphic, object, avatar, etc.) that they have not joined yet, but that they have checked in. This allows the other meeting participants to see that the invitee intends on joining the meeting. When checking in, the invitee can also enter a text status that is displayed next to (adjacent to) the invitee's name (i.e., any suitable user ID being used to represent the invitee) in the meeting participant list.

The invitee can also enter any free form text such as “Be There in 8 Minutes,” “Running Late,” or “Start Without Me.” The administrator or meeting organizer can also configure a list of predetermined (e.g., canned, preconfigured, etc.) messages. In one or more embodiments, the invitee checking in can then easily select any of those predetermined messages from a menu list. For mobile clients, the invitee can also choose an estimated time of arrival option. When choosing the ETA option, the mobile endpoint calculates the ETA based on the invitee's current location, destination location, and rate of speed (e.g., which can be based on GPS technology, an accelerometer, etc.). The ETA can then be displayed next to the invitee's name in the meeting participant list, along with any text status that is applicable. Once the invitee joins the meeting and is a current participant, their check in status may be cleared.

A mobile client may allow a meeting check in protocol for invitees, along with setting an appropriate text status. The mobile client may also automatically calculate the invitee's ETA for the meeting. Once checked in, the invitee may be added to the meeting participant list and the text status, where the ETA is displayed next to the invitee's name. Such a functionality can be viewed as a productivity enhancer in allowing invitees to easily communicate when they are running late to a meeting. This allows the other meeting participants to use their time wisely since they now know when key participants will be joining the meeting.

Note that, by contrast, existing frameworks involve individual chat messages that can easily be buried if there are several messages in the chat window. In many cases, these chat messages go unnoticed by other attendees. In certain embodiments of the present disclosure, the ETA status is displayed adjacent to the invitee's name (where participants would naturally/intuitively look). In addition, in certain embodiments described in this disclosure, the ETA may automatically be calculated and updated, which can be useful when the invitee is driving in a car, heading towards the meeting location on foot, etc. In contrast, using a chat window to communicate similar information would require a manual entry, which is both inconvenient and, potentially, dangerous if the user happens to be driving.

In one or more embodiments, the ETA is automatically calculated and/or periodically updated. Other attendees can see at a glance that the invitee is checked in and that the invitee is expected to join the meeting shortly (e.g., a number of minutes). In one embodiment, the mobile client automatically calculates the invitee's ETA and periodically updates the meeting server with the invitee's anticipated arrival information (e.g., based on the location and speed that the invitee is traveling).

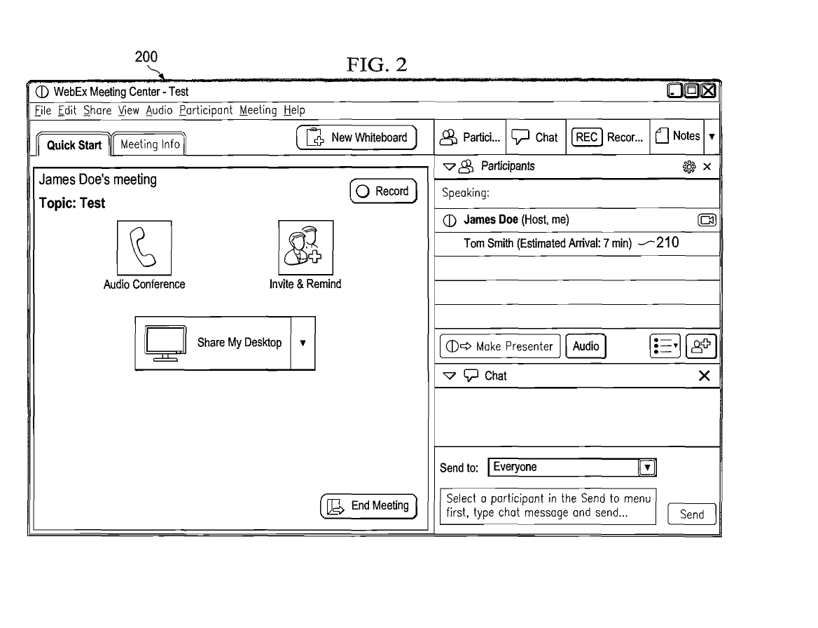

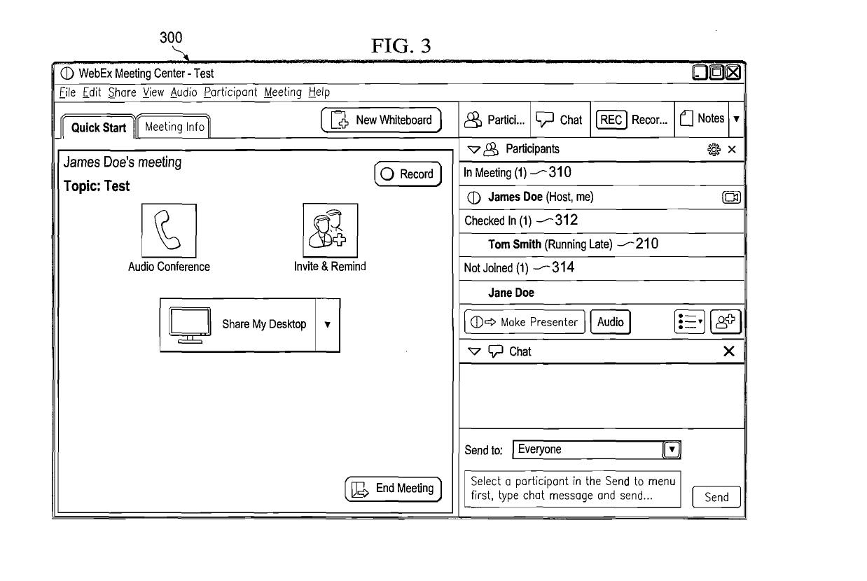

FIGS. 2-3 are illustrations showing example user interface representations associated with a meeting client program, which may be provisioned and/or otherwise executed by a server, according to at least one example embodiment. The representations of FIGS. 2-3 are merely examples and do not limit the claims in any way. For example, the representation of the meeting client program may vary, the information represented may vary, the format may vary, the position of representations may vary, the number of representations associated with status information and/or arrival information may vary, the size of representation associated with conversation status information and/or arrival information may vary, and/or the like.

In at least one example embodiment, a meeting client program may provide a representation of anticipated arrival information and a representation of status information, and/or the like. Such a representation may relate to causing visual display of information, playing of audio information, providing a tactile signal, etc. For example, visual display of information may be a text representation, a graphical representation, such as an image or a video, and/or the like.

FIG. 2 is an illustration showing example user interface representations 200 associated with a meeting client program according to at least one example embodiment. The example of FIG. 2 shows representation a 210 with respect to a meeting client program user interface. In at least one example embodiment, representation 210 comprises a representation of anticipated arrival information. For example, if anticipated arrival information indicates a message about the arrival of an invitee, the representation of the anticipated arrival information may be a representation that makes any viewer of the representation aware of, at least part of, the status of the anticipated arrival information. For example, representation 210 may comprise text stating “Estimated Arrival: 7 min”, “Be there in 8 minutes”, “Running late,” “Start without me,” any custom message from the invitee or from the meeting client program, and/or the like. In another example, if anticipated arrival information indicates an estimated time of arrival or the like, the representation of arrival information may comprise text stating arrival time that is updated continuously and/or periodically, a progress bar indicating time passage, and/or the like.

In at least one example embodiment, representation 210 comprises a representation of anticipated arrival information. This representation may be a change in color of a representation of the arrival information, removal of representation of the arrival information, a text statement indicating arrival information, and/or the like.

FIG. 3 is an illustration showing example user interface representations 300 associated with a meeting client program according to at least one example embodiment. The example of FIG. 3 shows a representation 310, a representation 312, and a representation 314 with respect to a meeting client program user interface. In at least one example embodiment, representations 310, 312, and 314 each comprise a representation of a grouping of invitees. In at least one example embodiment, representation 310 comprises a representation of invitees that are already in the meeting. For example, if status information indicates that one invitee, James Doe, is in the meeting the representation of the status information may be a representation that makes the viewer of the representation aware that James Doe is in the meeting. For example, the representation may group James Doe in a group that states “In Meeting,” generate a suitable status identifier of any kind next to James Doe's name, adjust the color of James Doe, and/or the like.

In another example, representation 312 comprises a representation of invitees that have checked into the meeting, but not yet arrived. For example, if status information indicates that one invitee is checked in, Tom Smith, the representation of the status information may be a representation that makes the viewer of the representation aware that Tom Smith is checked into the meeting. For example, the representation may group Tom Smith in a group that states “Checked In,” generate a suitable status identifier of any kind next to James Doe's name, adjust the color of Tom Smith, and/or the like.

In another example, representation 314 comprises a representation of invitees that have not joined or check into the meeting. For example, if status information indicates that one invitee is not joined, Jane Doe, the representation of the status information may be a representation that makes the viewer of the representation aware that Jane Doe is not joined into the meeting. For example, the representation may group Jane Doe in a group that states “Not Joined,” generate a suitable status identifier of any kind next to James Doe's name, adjust the color of Tom Smith, and/or the like.

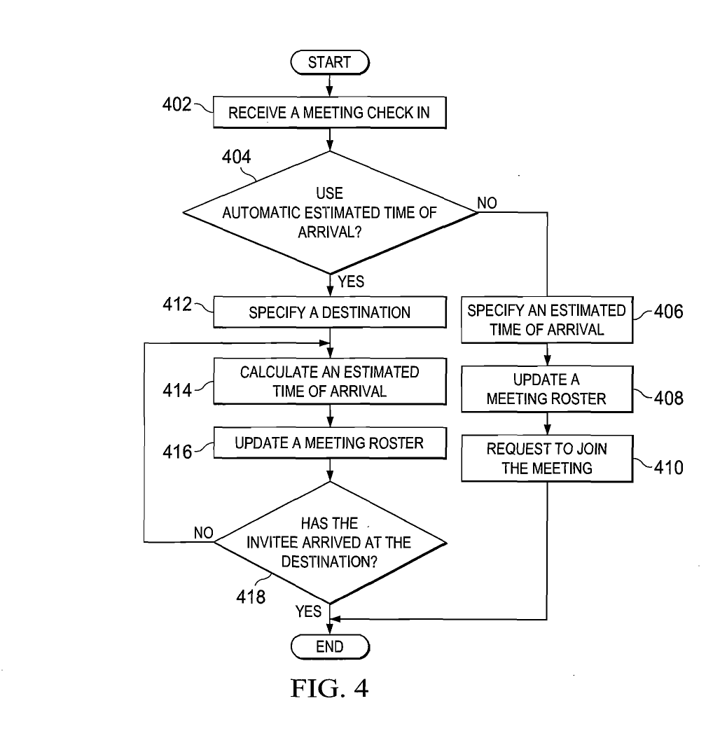

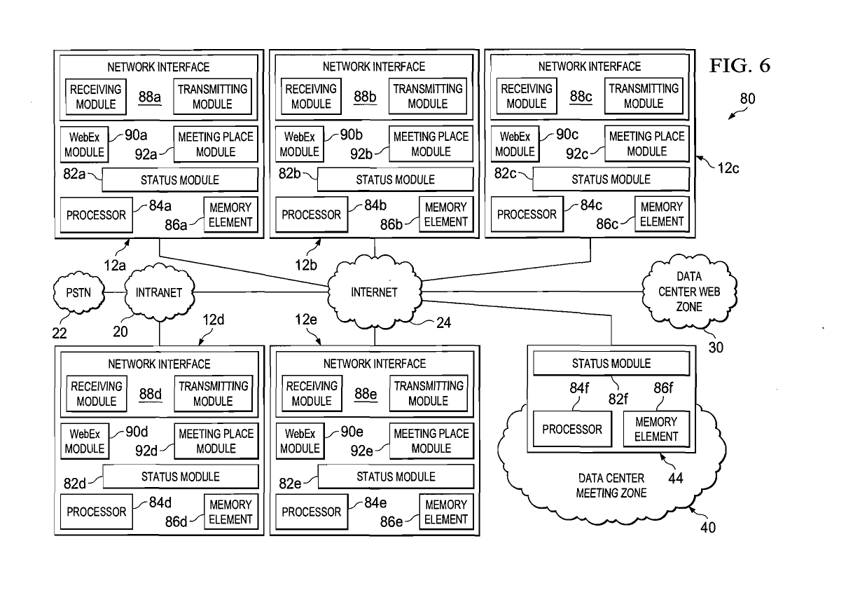

FIG. 4 is a flow diagram illustrating activities associated with managing arrival information according to at least one example embodiment. In at least one example embodiment, a set of operations corresponds to the activities of FIG. 4. An apparatus, for example any type of server, or MCS/MCC 44 of FIG. 1 and FIG. 6, or any portion thereof, may utilize the set of operations. The apparatus may comprise means, including, for example processor 84f of FIG. 6, for performing such operations. In an example embodiment, an apparatus, for example any type of server, MCS/MCC 44 of FIG. 1 and FIG. 6, is transformed by having memory, for example memory element 86f of FIG. 6, comprising computer code configured to, working with a processor, for example processor 84f of FIG. 6, cause the apparatus to perform set of operations of FIG. 4.

At block 402, the apparatus receives a meeting check in. In at least one example embodiment, the meeting check in information is received from a repository, such as data center web zone 30. In such an embodiment, a meeting session participant may have previously entered anticipated arrival information in the repository, for example, when the meeting session was scheduled, at a time between the scheduling of the meeting session and the beginning of the meeting session, when setting default meeting session characteristics, and/or the like. In at least one example embodiment, arrival information may be received directly from an endpoint. In at least one example embodiment, the arrival information can be either received before the beginning of the meeting session or during the meeting session.

In at least one example embodiment, the status and/or arrival information is received after the beginning of the meeting session. In at least one example embodiment, the apparatus causes a meeting client program to provide a representation of the status and/or arrival information. In at least one example embodiment, generation of representation 210 is caused by sending the status and/or arrival information, a notification indicating a change in the status and/or arrival information, and/or the like.

At block 404, the apparatus may determine whether to use an automatic estimated time of arrival (ETA). Automatic ETA may use the components of a mobile endpoint used as an endpoint to calculate ETA based on a current location, a destination, and a rate of speed. For example, the invitee may be currently located on the other side of a company facility with respect to the destination. The destination may be a target computer (i.e., an employee workstation), a Wi-Fi area, a meeting location, a group conference room, and/or the like. In a scenario using automatic ETA, the mobile endpoint may calculate the ETA using these points of information, along with a map, distance, actual rate of speed, typical rate of speed for transportation type, or estimated rate of speed based on traffic factors, speed limits, and/or the like.

At block 406, if automatic ETA is not selected, the apparatus may specify the ETA. The apparatus may use a predetermined ETA, receive input from an invitee, and/or the like. At block 408, the apparatus may update the meeting roster. The meeting roster may be updated with anticipated arrival information and/or status information. At block 410, the apparatus may request to join the meeting. The request to join the meeting may occur upon receiving input from the invitee, based off a geographical proximity to the meeting, and/or the like.

At block 412, if automatic ETA is selected, the apparatus may specify a destination. The apparatus may obtain the destination from the meeting information, from an invitee, and/or the like. At block 414, the apparatus may calculate an ETA. For example, the mobile endpoint may calculate the ETA using current location information, global positioning system information, nearby cellular towers, nearby Wi-Fi routers, along with a map, distance, actual rate of speed, typical rate of speed for transportation type, or estimated rate of speed based on traffic factors, speed limits and/or the like.

At block 416, the apparatus may update the meeting roster. The meeting roster may be updated with anticipated arrival information and/or status information. At block 418, the apparatus may determine whether the invitee has arrived at the destination. The apparatus may perform block 418 continuously, upon request, and/or periodically. If the invitee has not arrived at the destination, the apparatus may repeat block 414. If the invitee has arrived at the destination, then the flow may terminate.

In an embodiment, as the flow depicted in FIG. 4 is from the viewpoint of the endpoint and invitee, complimenting operations may be performed by MCSs/MCC 44. Additionally, MCSs/MCC 44 may perform the automatic ETA calculations on behalf of the endpoint using similar information received from the endpoint.

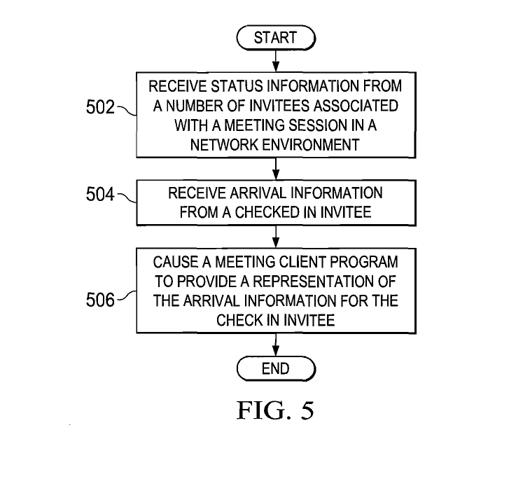

FIG. 5 is a flow diagram illustrating activities associated with managing status and anticipated arrival information according to at least one example embodiment. In at least one example embodiment, a set of operations corresponds to the activities of FIG. 5. An apparatus, for example any type of server, MCS/MCC 44 of FIG. 1 and FIG. 6, or a portion thereof, may utilize the set of operations. The apparatus may comprise means, including, for example processor 84f of FIG. 6, for performing such operations. In an example embodiment, an apparatus, for example any type of server, MCS/MCC 44 of FIG. 1 and FIG. 6, is transformed by having memory, for example memory element 86f of FIG. 6, comprising computer code configured to, working with a processor, for example processor 84f of FIG. 6, cause the apparatus to perform set of operations of FIG. 5.

At block 502, the apparatus receives status information from a number of invitees (i.e., endpoints) associated with a meeting session in a network environment. The status information may indicate whether the number of invitees has checked into the meeting session. Note that as used herein, the term ‘status information’ includes any information associated with a meeting invitee, a meeting participant, etc., along with any data indicative of whether such an individual or endpoint has checked in, gone offline, come online, been active for a certain period, communicated with a server, interacted with a repository, etc. At block 504, the apparatus may receive arrival information from a checked in invitee. In an example embodiment, the arrival information is provided via a message from the invitee. As used herein, the term ‘arrival information’ includes any information associated with an arrival time, an estimating arrival time, a projected arrival time, a scheduled arrival time, or an indicated arrival time (e.g., provided by the host, an invitee, etc.) for a meeting invitee, a meeting participant, etc. In another example, the arrival information is an estimated time of arrival of the invitee. In a specific embodiment, the arrival information may be received from a repository.

In a specific embodiment, the arrival information includes location information. Additionally, the apparatus may calculate an estimated time of arrival of the invitee using the location information and update the arrival information with the estimated time of arrival. In a specific embodiment, the location information may include a current location of the invitee, a destination of the invitee, and a rate of speed of the invitee. At block 506, the apparatus may cause a meeting client program to provide a representation of the arrival information for the checked in invitee. In a specific embodiment, the meeting client may provide the representation to all of the invitees or only the host of the meeting session.

FIG. 6 is a simplified schematic diagram illustrating possible details related to an example infrastructure of a communication system 10 in accordance with at least one example embodiment. Each of endpoints 12a-e are provisioned with a respective status module 82a-e, a respective processor 84a-e, a respective memory element 86a-e, a respective WebEx module 90a-e, a respective Meeting Place module 92a-e, and a respective network interface 88a-e, which includes a respective receiving module and a respective transmitting module for exchanging data (e.g., for exchanging packets in a network environment). FIG. 6 illustrates an example implementation of MCSs/MCC 44 that is similarly provisioned with a status flow module 82f, a processor 84f, and a memory element 86f.

In at least one example embodiment, each endpoint 12a-e and/or MCSs/MCC 44 includes software (e.g., as part of status flow modules 82a-f) to achieve or to support managing status and/or arrival times associated with a meeting session, as outlined herein in this document. In other embodiments, this feature may be provided externally to any of the aforementioned elements, or included in some other network element to achieve this functionality. Alternatively, several elements may include software (or reciprocating software) that may coordinate in order to achieve the operations, as outlined herein. In still other embodiments, any of the devices of the FIGURES may include any suitable algorithms, hardware, software, components, modules, interfaces, or objects that facilitate in managing a meeting session.

It is imperative to note that FIG. 6 is indicative of just one, of the multitude, of example implementations of communication system 10. Any of the modules or elements within endpoints 12a-e and/or MCSs/MCC 44 may readily be replaced, substituted, or eliminated based on particular needs. Furthermore, although described with reference to particular scenarios, where a given module (e.g., WebEx module 90a-e, Meeting Place module 92a-e, status modules 82a-e, etc.) is provided within endpoints 12a-e or MCSs/MCC 44, any one or more of these elements may be provided externally, or consolidated and/or combined in any suitable fashion. In certain instances, certain elements may be provided in a single proprietary module, device, unit, etc. in order to achieve the teachings of the present disclosure.

Endpoints 12a-e are representative of any type of client, invitee, or user wishing to participate in a meeting session in communication system 10 (e.g., or in any other online platform). Furthermore, endpoints 12a-e may be associated with individuals, clients, customers, or end users wishing to participate in a meeting session in communication system 10 via some network. The term ‘endpoint’ is inclusive of devices used to initiate a communication, such as a computer, a personal digital assistant (PDA), a laptop or electronic notebook, a cellular telephone of any kind, an iPhone™, an IP phone, a Blackberry, a Google Droid™, an iPad™, a tablet, an Ultrabook™, a Microsoft Surface™, or any other device, component, element, or object capable of initiating voice, audio, video, media, or data exchanges within communication system 10. Endpoints 12a-e may also be inclusive of a suitable interface to the human user, such as a microphone, a display, or a keyboard or other terminal equipment. Endpoints 12a-e may also be any device that seeks to initiate a communication on behalf of another entity or element, such as a program, a proprietary conferencing device, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another.

MCSs/MCC 44 and web servers 32 are network elements that manage (or that cooperate with each other in order to manage) aspects of a meeting session. As used herein in this Specification, the term ‘network element’ is meant to encompass any type of servers (e.g., a video server, a web server, a meeting server (e.g., for hosting a meeting), etc.), routers, switches, gateways, bridges, loadbalancers, firewalls, inline service nodes, proxies, network appliances, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information. In one particular example, MCSs/MCC 44 and web servers 32 are servers that may interact with each other via the networks of FIG. 1.

Intranet 20, PSTN 22, and Internet 24 represent a series of points or nodes of interconnected communication paths for receiving and transmitting packets of information that propagate through communication system 10. These networks may offer connectivity to any of the devices or endpoints of FIG. 1. Moreover, Intranet 20, PSTN 22, and Internet 24 offer a communicative interface between sites (and/or participants, rooms, etc.) and may be any local area network (LAN), wireless LAN (WLAN), metropolitan area network (MAN), wide area network (WAN), extranet, Intranet, virtual private network (VPN), virtual LAN (VLAN), or any other appropriate architecture or system that facilitates communications in a network environment.

Intranet 20, PSTN 22, and Internet 24 may support a transmission control protocol (TCP)/IP, or a user datagram protocol (UDP)/IP in particular embodiments of the present disclosure; however, Intranet 20, PSTN 22, and Internet 24 may alternatively implement any other suitable communication protocol for transmitting and receiving data packets within communication system 10. Note also that Intranet 20, PSTN 22, and Internet 24 may accommodate any number of ancillary activities, which may accompany a meeting session. This network connectivity may facilitate all informational exchanges (e.g., notes, virtual whiteboards, PowerPoint presentations, e-mailing, word-processing applications, etc.). Along similar reasoning, Intranet 20, PSTN 22, and Internet 24 may foster all such communications and, further, be replaced by any suitable network components for facilitating the propagation of data between participants in a conferencing session.

It should also be noted that endpoints 12a-e and MCSs/MCC 44 may share (or coordinate) certain processing operations. Using a similar rationale, their respective memory elements may store, maintain, and/or update data in any number of possible manners. Additionally, any of the illustrated memory elements or processors may be removed, or otherwise consolidated such that a single processor and a single memory location is responsible for certain activities associated with managing a meeting session. In a general sense, the arrangement depicted in FIG. 6 may be more logical in its representations, whereas a physical architecture may include various permutations/combinations/hybrids of these elements.

Note that in certain example embodiments, the meeting session management functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element (as shown in FIG. 6) may store data used for the operations described herein. This includes the memory element being able to store software, logic, code, or processor instructions that may be executed to carry out the activities described in this Specification. A processor may execute any type of instructions associated with the data to achieve the operations detailed herein in this Specification. In one example, the processor (as shown in FIG. 6) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, status modules 82a-f include software in order to achieve the meeting session management functions outlined herein. These activities may be facilitated by MCSs/MCC 44 and/or the various endpoints 12a-f. MCSs/MCC 44 and/or endpoints 12a-f may include memory elements for storing information to be used in managing one or more status for a meeting session, as outlined herein. Additionally, MCSs/MCC 44 and/or endpoints 12a-f may include a processor that may execute software or an algorithm to perform management of a meeting session, as discussed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term ‘memory element.’ Similarly, any of the potential processing elements, modules, and machines described in this Specification should be construed as being encompassed within the broad term ‘processor.’

Note that with the examples provided herein, interaction may be described in terms of two or three elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and may accommodate a large number of rooms and sites, as well as more complicated/sophisticated arrangements and configurations. Accordingly, the examples provided herein should not limit the scope or inhibit the broad teachings of communication system 10 as potentially applied to a myriad of other architectures. Additionally, although described with reference to particular scenarios where MCSs/MCC 44 resides in a particular physical location, MCSs/MCC 44 may reside in any location, provided it has some connectivity to a suitable network.

It is also important to note that the steps discussed with reference to FIGS. 1-6 illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in WebEx and Meeting Place conferencing environments or arrangements, the present disclosure may be used in any online environment that could benefit from such technology. For example, in certain instances, computers that are coupled to each other in some fashion may utilize the teachings of the present disclosure (e.g., even though participants would be in a face-to-face arrangement). Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
receiving status information from a number of endpoints associated with a meeting session in a network environment, wherein the status information includes, at least, information indicative of whether any of the number of endpoints have virtually checked into the meeting session;
receiving anticipated arrival information from a checked in endpoint; and
generating a representation of the anticipated arrival information to be viewed during the meeting session.

2. The method of claim 1, wherein the anticipated arrival information is provided by a message from the checked in endpoint.

3. The method of claim 1, wherein the anticipated arrival information includes an estimated time of arrival of the checked in endpoint based, at least in part, on global positioning system (GPS) technology.

4. The method of claim 1, wherein the anticipated arrival information comprises location information, and the method further comprises:
calculating an estimated time of arrival of the checked in endpoint using the location information; and
updating the anticipated arrival information with the estimated time of arrival.

5. The method of claim 4, wherein the location information comprises at least one of a current location of the checked in endpoint, a destination of the checked in endpoint, and a rate of speed of the checked in endpoint.

6. The method of claim 1, wherein the anticipated arrival information is received from a repository that tracks the status information for the number of endpoints.

7. The method of claim 1, wherein generating comprises providing a representation of the anticipated arrival information adjacent to a user identifier during the meeting session.

8. The method of claim 1, further comprising:
providing a list of one or more predetermined messages for a particular endpoint to select to provide particular anticipated arrival information for the particular endpoint.

9. An apparatus comprising at least one processor and at least one memory, the at least one memory including computer program instructions that, when executed by the at least one processor, cause the apparatus to:
receive status information from a number of endpoints associated with a meeting session in a network environment, wherein the status information includes, at least, information indicative of whether any of the number of endpoints have virtually checked into the meeting session;
receive anticipated arrival information from a checked in endpoint; and
generate a representation of the anticipated arrival information to be viewed during the meeting session.

10. The apparatus of claim 9, wherein the anticipated arrival information is provided by a message from the checked in endpoint.

11. The apparatus of claim 9, wherein the anticipated arrival information includes an estimated time of arrival of the checked in endpoint based, at least in part, on global positioning system (GPS) technology.

12. The apparatus of claim 9, wherein the anticipated arrival information comprises location information, and the apparatus is further configured to:
calculate an estimated time of arrival of the checked in endpoint using the location information; and
update the anticipated arrival information with the estimated time of arrival.

13. The apparatus of claim 12, wherein the location information comprises at least one of a current location of the checked in endpoint, a destination of the checked in endpoint, and a rate of speed of the checked in endpoint.

14. The apparatus of claim 9, wherein the anticipated arrival information is received from a repository that tracks the status information for the number of endpoints.

15. The apparatus of claim 9, wherein generating comprises providing a representation of the anticipated arrival information adjacent to a user identifier during the meeting session.

16. A non-transitory computer readable medium comprising instructions that, when executed by a processor, cause an apparatus to:
receive status information from a number of endpoints associated with a meeting session in a network environment, wherein the status information includes, at least, information indicative of whether any of the number of endpoints have virtually checked into the meeting session;
receive anticipated arrival information from a checked in endpoint; and
generate a representation of the anticipated arrival information to be viewed during the meeting session.

17. The media of claim 16, wherein the anticipated arrival information is provided by a message from the checked in endpoint.

18. The media of claim 16, wherein the anticipated arrival information includes an estimated time of arrival of the checked in endpoint based, at least in part, on global positioning system (GPS) technology.

19. The media of claim 16, wherein the arrival information comprises location information, and wherein the instructions further cause the apparatus to:
calculate an estimated time of arrival of the checked in endpoint using the location information; and
update the anticipated arrival information with the estimated time of arrival.

20. The media of claim 16, wherein the anticipated arrival information is received from a repository that tracks the status information for the number of endpoints.
